(19) United States
(12) Patent Application Publication
(10) Pub. No.: US 2007/0231768 A1
(43) Pub. Date: Oct. 4, 2007

(54) System and method for orthodontic retention

(76) Inventor: Arnoldo Carlos Hutchinson, Oak Brook, IL (US)

Correspondence Address: Arnoldo Hutchinson, DDS, 22 Brighton Lane, Oak Brook, IL, 60523, US

(21) Appl. No.: 11/395,241

(22) Filed: Apr. 3, 2006

(51) Int. Cl. A61C 3/00

(52) U.S. Cl. 433/24; 433/8; 433/20

(57) ABSTRACT

A system and method for orthodontic retention is provided. The orthodontic retention system has one or more orthodontic archwires to define and maintain tooth position. The system also has two or more orthodontic brackets affixed to two or more teeth to engage the archwire with the teeth. The method for orthodontic retention defines the use of the orthodontic retention system. The system and method for orthodontic retention is one that requires no overt action by the patient, is not highly vulnerable to damage, is easy to adjust or replace, allows access to the teeth for cleaning and dental care, is nearly invisible, allows therapeutic force during the retention period and allows slight physiologically-necessary movement of the teeth.

### BACKGROUND OF THE INVENTION

1. Field of the Invention

This invention relates generally to orthodontics. More specifically, this invention relates to systems and methods for orthodontic retention.

2. Description of the Related Art

For a period of time following orthodontic treatment, the involved teeth have a normal tendency to return to their original position. Until the bones and ligaments of the affected area heal or adapt to accommodate the new positions and orientation, the teeth must be held somewhat fixed. This may also be the case following oral or plastic surgery to repair accident damage, correct genetic anomalies or accommodate cosmetic preferences. (In this disclosure “retainer” is used to refer to an apparatus, system or method for maintaining the position of teeth. Similarly, “retention” is used to refer to the act of holding the teeth in position.)

For many years, there have been two predominant approaches for retaining the teeth in a fixed position. First, a removable plate-like apparatus is used similar to those described in U.S. Pat. No. 3,967,379 or U.S. Pat. No. 4,073,061. This type of retainer is made from a mold of the patient's teeth and custom fitted to the new or corrected tooth position. The second type of retainer is generally described as a rigid archwire that is bonded with resin to the lingual surface of the teeth in a semi-permanent, fixed manner.

Regrettably these approaches have problems that make them only marginally effective and result in the loss of the orthodontic effect on the teeth over time.

First, there is an issue with compliance and cooperation on the part of the patient. The first type of retainer is removable and patients are frequently neglectful in the use of the appliance during this sometimes protracted phase. This is a result of discomfort, lack of discipline and modesty regarding appearance of the appliance. These problems are particularly true of the adolescents who comprise a large percentage of the patient population.

The second problem that inhibits effectiveness of conventional retainers is damage. The Type 1 retainer is somewhat fragile and, if not cared for properly, is subject to damage requiring costly repairs or replacement. Similarly, bending or breakage of the resin holding the archwire on one or more teeth in the Type 2 retainer is time consuming and inconvenient to repair.

Third, both retainer models are difficult to change as orthodontic needs change. The removable, Type 1 retainer can be adjusted for minor changes but this is limited. The permanently affixed retainer, Type 2, must be completely removed and a new apparatus attached to make any change.

Cleaning is a considerable problem, particularly with the Type 2, permanent retainer. It is difficult to impossible for the patient or dental professional to adequately clean the teeth. Similarly, corrective or restorative dental work cannot be completed with the Type 2 apparatus in place. As an added complication, the apparatus itself encourages build up of food particles, bacteria, and plaque that become trapped in creases and joints. This increases the need for prophylactic and remedial dental care.

A fifth problem, Type 1 retainers are visible in the mouth of the patient. This is an aesthetically undesirable effect and exacerbates the compliance issue.

Finally, both types of retainer are somewhat rigid. While they restrict the teeth from returning to their pre-treatment position, they also substantially prevent required minute movement of the teeth, fore and aft and up and down. This movement is physiologically necessary to stimulate the bone and connective tissue adaptation that will permanently hold the patient's teeth in the desired position. The Type 1 retainer holds teeth rigid fore and aft but provides no vertical control. The type 2 retainer allows some movement but all of the teeth move in unison rather than individually. This is not sufficient to stimulate the required physiological adjustment.

The disclosed system and method are directed to overcoming one or more of the problems set forth above.

### BRIEF SUMMARY OF THE INVENTION

In one aspect, the present disclosure is directed to an orthodontic-retention system that allows minute movement of the teeth while holding them in the desired orthodontic position and prohibiting relapse. The orthodontic-retention system includes one or more orthodontic archwires selected and formed to hold teeth in a required position. The orthodontic retention system also includes two or more orthodontic brackets that are affixed to two or more teeth in a semi-permanent manner for the purpose of engaging the archwire with the teeth. The insertion of the archwire into the brackets and adjustment of the archwire serves to define and maintain the position of the involved teeth.

In another aspect, the present disclosure is directed to a method of retaining a desired position of one or more teeth. The method includes selecting an archwire composition, defining the shape of the archwire and forming the archwire into the defined shape. The method also includes defining the attachment points for the orthodontic brackets, selecting the appropriate orthodontic brackets for the application, affixing two or more orthodontic brackets to two or more teeth in a semi-permanent manner, inserting the archwire into the brackets and adjusting the final position of the archwire.

### BRIEF DESCRIPTION OF THE SEVERAL VIEWS OF THE DRAWINGS

FIG. 1 is a drawing showing an example of an orthodontic bracket affixed to a tooth and an orthodontic archwire inserted into the horizontal slot of the bracket.

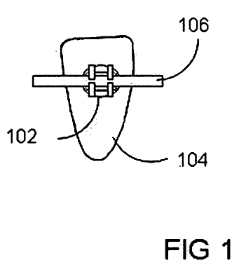

FIG. 2 is a drawing showing one example of the system for orthodontic retention in which the retention system is applied to two adjacent teeth.

FIG. 3 is a drawing showing one example of the system for orthodontic retention in which the retention system is applied to a number of adjacent teeth with brackets attached to each tooth.

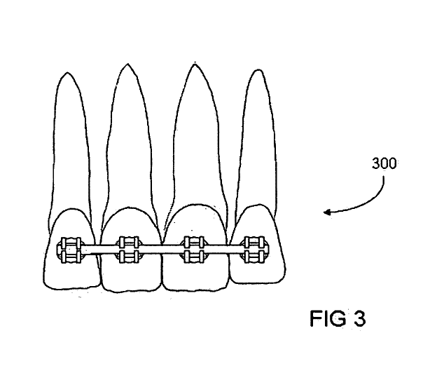

FIG. 4 is a drawing showing one example of the system for orthodontic retention in which the brackets are not attached to every tooth to be retained by the system.

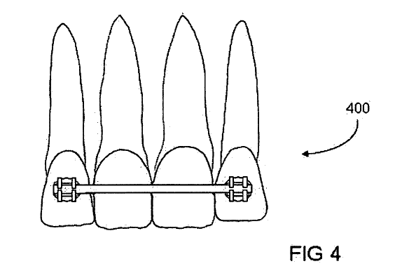

FIG. 5 is a drawing showing an example of an orthodontic bracket attached to a tooth.

FIG. 6 is a drawing showing a lateral view of an example of a circular-cross-section orthodontic archwire inserted into an orthodontic bracket.

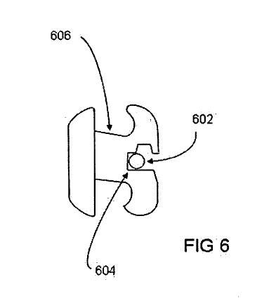

FIG. 7 is a drawing showing a lateral view of an example of a non-circular-cross-section orthodontic archwire inserted into an orthodontic bracket.

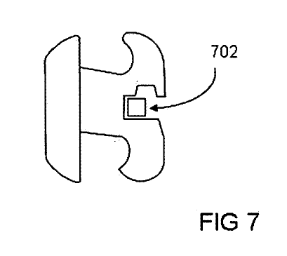

FIG. 8 is a drawing showing an example of a thin orthodontic archwire attached to the brackets in the form of a FIG. 8.

FIG. 9 is a schematic diagram illustrating the method of using the system for orthodontic retention.

### DETAILED DESCRIPTION OF THE INVENTION

The invention disclosed is a system and method of retaining the position of one or more teeth that, relative to existing solutions, requires no overt action by the patient, is less vulnerable to damage, is easier to adjust or replace, allows the immediate removal of the archwire and access to the teeth for cleaning and dental care, is less visible, allows therapeutic force during the retention period and allows slight physiologically-necessary movement of the teeth.

The system includes orthodontic brackets 102 affixed to the teeth 104 and an arch wire 106 connected in such a way as to prohibit significant movement of the teeth to an undesirable position or orientation.

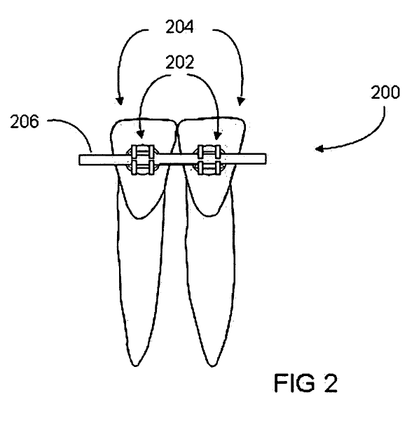

FIG. 2 illustrates a simple example of the orthodontic retention system 200 having two orthodontic brackets 202 affixed to two teeth 204 and an archwire 206 inserted into the brackets. The orthodontic-retention system may involve a plurality of teeth with brackets affixed to each tooth 300 or to some of the teeth 400. When thus assembled, the archwire defines the position to be held by the engaged teeth and retains them in that position.

The orthodontic-retention system may include a plurality of orthodontic archwires and a plurality of orthodontic brackets.

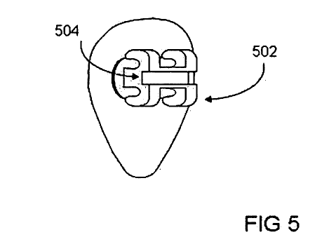

FIG. 5 illustrates an example of an orthodontic bracket. This bracket 502 may be of any type known in the art having a horizontal slot 504 or a vertical slot that is appropriate to the application. Self-ligating brackets and wingless brackets are examples.

The slot in the bracket may be of any appropriate shape, orientation and dimensions to allow insertion of the arch wire and the required therapeutic effect.

The bracket dimensions will be appropriate to the intended attachment surface. For example, brackets to be attached to the lingual surface of the tooth may be of smaller dimensions than brackets applied to the labial surface of the tooth.

The shape and form of the bracket would be dictated by the intended attachment surface. For example, brackets to be attached to the lingual surface of the tooth may be rounder and smoother having fewer squared edges than brackets to be attached to the labial surface.

The brackets in the orthodontic-retention system may be affixed to any tooth surface as dictated by the application including the lingual, labial, buccal, cuspal, proximal and distal surfaces. The orthodontic-retention system may be used on either the maxillary teeth or the mandibular teeth. If used on the maxillary teeth, a bite ramp or a hybrid between a bracket and a bite ramp may be necessary to prevent the brackets from loosening or being bitten off by the opposing teeth.

The orthodontic archwire may be composed of resilient or shape-memory material such as Nitinol, stainless steel and other metallic alloys.

The orthodontic archwire may have a circular cross-section 602 so that it can move freely in the slot 604 in the bracket 606.

The arch wire may be of non-circular cross-section 702 (such as a rectangular cross section) and of a dimension that it cannot rotate within the bracket slot. This allows application of torque to the tooth as may be therapeutically required during the retention period without restricting the minute physiological movement of the teeth. This is a feature of this system that is not found in current retention options.

The orthodontic archwire may be of any appropriate dimensions provided that the diameter is not greater than that allowed by the bracket slot.

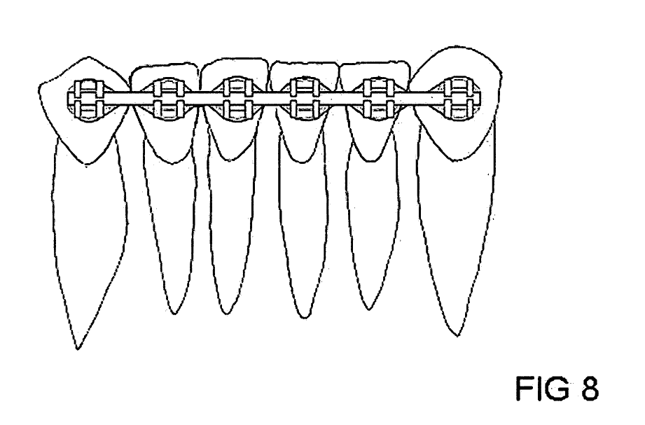

The orthodontic archwire may be a singular strand, either hollow or solid, or may be composed of a plurality of such strands aligned in parallel, twisted or inter-woven with each other. The orthodontic archwire may be engaged with the brackets by any method that is appropriate for the therapeutic effect. For example FIG. 8 illustrates the attachment of the archwire in a figure-8 configuration in addition to the strait application shown in other examples.

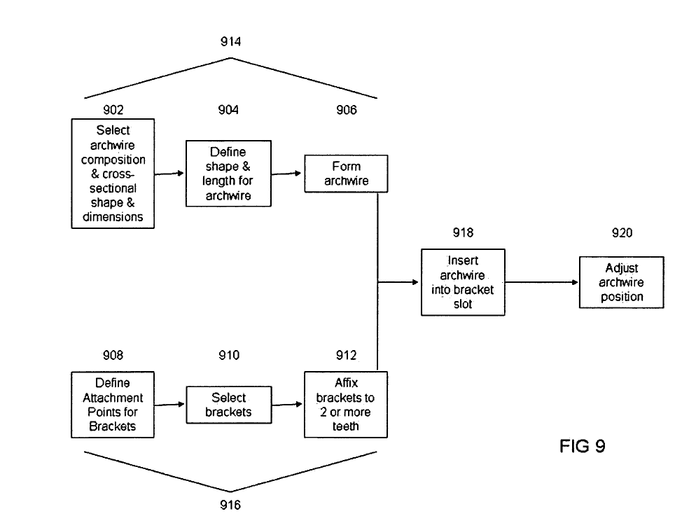

The disclosed system for orthodontic retention may be applicable to any use that includes retaining teeth in a particular position. The disclosed system may retain orthodontic adjustment, correction or repair until the ligaments and bone of the patient have adjusted to accommodate the tooth position. The disclosed system may be used in conjunction with traditional braces to achieve desired therapeutic effects such as anchorage for application of force. The disclosed system allows for effective control of vertical movement of the teeth. The method for using the orthodontic-retention system is illustrated in FIG. 9. (For this discussion, the term “practitioner” will be used to refer to an individual who uses the disclosed system or method and it is assumed that different steps may be executed by different practitioners.)

First, the practitioner will select an archwire type to be used in the orthodontic-retention system 902. The material composition and cross-sectional attributes will be dictated by the demands of the application including, but not limited to the patient's habits, size, and history, the therapeutic requirements, and the expected length of the retention period.

Once the orthodontic archwire type has been selected, the practitioner will define the length and shape of the archwire 904. The length and shape may be dictated by the distance to be traversed by the archwire and the shape of the patient's teeth and the dental arch of the teeth to be engaged.

The practitioner will next form the selected orthodontic archwire into the defined shape 906. This may be accomplished by any method known in the art as is appropriate for the archwire type, length and shape.

In the next step of the method for orthodontic retention, the practitioner will define the number and location of attachment points for the orthodontic brackets 908. This will be determined by the therapeutic requirements and may include two or more attachment points.

Next, the practitioner will select the brackets for the application 910. The bracket chosen may be any orthodontic bracket known in the art of a size and type appropriate for the patient, the attachment point and the therapeutic requirements.

The practitioner will then affix the orthodontic brackets to the teeth at the defined points of attachment 912. The method of attachment may be any semi-permanent method known in the art as dictated by the environment and therapeutic requirements.

It should be noted that the archwire steps 914 and the bracket steps 916 may be performed in any order or simultaneously. More specifically, the archwire steps may be performed first, the bracket steps may be performed first, or the archwire steps may be performed while the bracket steps are being performed.

In the next step, the orthodontic archwire is inserted into the slots of the brackets 918. The method of insertion and ligation may be dictated by the requirements of the chosen bracket type.

Finally, the position of the archwire is adjusted 920. The archwire will align with the position of the teeth and brackets according to the therapeutic requirements.

Several advantages over the prior art may be associated with the system and method for orthodontic retention. Since the system is affixed to the teeth in a semi-permanent manner, it requires no overt action by the patient. Compliance is thus 100%. This system is not as susceptible to damage as Type 1 or Type 2 retainers. If damage to an archwire occurs, it can be repaired quickly and less expensively by opening the brackets and replacing the archwire since it is not bonded to the teeth. Similarly, a single damaged bracket can be replaced without replacing the entire retention system. If there is a change in the orthodontic requirements, the archwire can be removed and a new one inserted. Again, it isn't necessary to replace the entire system or “unbond” the attachment points. The disclosed orthodontic-retention system allows for easy cleaning and dental work. The archwire is simply removed from the brackets before the procedure and reseated afterwards. Depending on the tooth surfaces chosen for bracket attachment the orthodontic-retention system may be invisible to the outside which is desirable for the patient. The selection of brackets and attachment points may also yield a more comfortable result for the patient. The use of certain archwires may allow for further therapeutic effects by application of torque to the engaged teeth during retention. Additionally, the system could be used in conjunction with braces during the adjustment phase of orthodontic treatment to effect certain therapeutic results and the use of the system may allow the patient to move from the adjustment phase to the retention phase earlier. The system also allows for control of the vertical movement of the teeth during the retention phase. Finally the orthodontic-retention system allows for minute 3-dimensional movement of the teeth because of the flexibility of the archwire once engaged in the slots of the brackets. In particular, the use of resilient metals in the archwire may enhance this effect by improving the archwire's ability to move and also to maintain the desired shape and position.

It will be apparent to those skilled in the art that various modifications and variations can be made to the system for orthodontic retention. Other embodiments will be apparent to those skilled in the art from consideration of the specification and practice of the disclosed system for orthodontic retention. In addition, there are likely to be other benefits of this system as yet not understood. It is intended that the specification and examples be considered as exemplary only with a true scope being indicated by the following claims and their equivalents.

The invention claimed is:

1. A system for orthodontic retention, comprising:
a. at least one orthodontic archwire to define and maintain tooth position; and
b. at least two orthodontic brackets semi-permanently affixed to two or more teeth to engage the archwire with the teeth.

2. The system as in claim 1 wherein the orthodontic brackets are attached to two or more adjacent teeth.

3. The system as in claim 1 comprising a plurality of archwires.

4. The system as in claim 1 comprising one or more self-ligating orthodontic brackets.

5. The system as in claim 1 wherein the orthodontic brackets are affixed to the lingual surface of one or more teeth.

6. The system as in claim 1 wherein the archwire is composed of any shape-memory alloy.

7. The system as in claim 1 wherein the composition of the archwire is selected from the group consisting of Nitinol, stainless steel, plastic, nylon, polyurethane, and metal alloy.

8. The system as in claim 1 wherein the composition of the archwire is selected from the group consisting of Nickel alloy, Titanium alloy, Copper alloy, Zinc alloy and Aluminum alloy.

9. The system as in claim 1 wherein the orthodontic archwire has a circular cross section.

10. The system as in claim 1 wherein the orthodontic archwire has a rectangular cross section.

11. The system as in claim 1 wherein the orthodontic archwire is a multi-stranded orthodontic archwire.

12. A method of orthodontic retention, comprising:
a. selecting an appropriate orthodontic-archwire composition and cross-sectional shape and dimensions;
b. defining an appropriate shape and length for the archwire;
c. forming the archwire;
d. selecting the orthodontic brackets for use in the system;
e. defining attachment points for two or more orthodontic brackets;
f. affixing two or more orthodontic brackets to two or more teeth in a semi-permanent manner;
g. inserting the archwire into the brackets; and
h. adjusting the archwire position.

13. A system for orthodontic retention, comprising:
a. two self-ligating orthodontic brackets composed of polycrystalline polymer and having a mesial-distal slot, semi-permanently affixed to the lingual surface of two teeth of the mandible; and
b. one solid, Nitinol orthodontic archwire inserted into the mesial-distal slot of the orthodontic brackets and configured to extend from the lower-right bracketed tooth to the lower-left bracketed tooth.

14. The system as in claim 13 wherein at least one of the brackets is affixed to a molar.

15. The system as in claim 13 wherein at least one of the brackets is affixed to a cuspid.

16. The system as in claim 13 wherein at least one of the brackets is affixed to a bicuspid.

17. The system as in claim 13 wherein the brackets are affixed to the lower-left cuspid and the lower-right cuspid and the orthodontic archwire has a quadrangular cross-sectional shape.

18. The system as in claim 13 wherein the brackets are affixed to either lower-left bicuspid and either lower-right bicuspid and the orthodontic archwire has a quadrangular cross-sectional shape.

19. The system as in claim 13 wherein the brackets are affixed to any lower-left molar and any lower-right molar and the orthodontic archwire has a quadrangular cross-sectional shape.
